(19) United States
(12) Patent Application Publication
(10) Pub. No.: US 2023/0203309 A1
(43) Pub. Date: Jun. 29, 2023

(54) ALKALI-RESISTANT BLACK MATTE POLYIMIDE FILM

(71) Applicant: TAIMIDE TECHNOLOGY INCORPORATION, Hsinchu Hsien (TW)

(72) Inventors: CHUN-HUA LI, Hsinchu Hsien (TW); YI-HSUEH HO, Hsinchu Hsien (TW)

(21) Appl. No.: 17/979,005

(22) Filed: Nov. 2, 2022

(30) Foreign Application Priority Data
Dec. 29, 2021 (TW) 110149409

(51) Int. Cl. C08L 79/08

(52) U.S. Cl. CPC C08L 79/08

(57) ABSTRACT

Provides an alkali-resistant black matte polyimide film, including polyimide in an amount from 75 to 93 wt % of the alkali-resistant black matte polyimide film, in which dianhydride and diamine are polymerized to form a polyimide precursor, and the polyimide precursor is chemically cyclized to form the polyimide, wherein the dianhydride includes pyromellitic dianhydride (PMDA) and 3,3′,4,4′-biphenyltetracarboxylic dianhydride (BPDA), and the diamine includes p-Phenylenediamine (PDA) and 4,4′-oxydianiline (ODA), and wherein the BPDA is an amount from 2 to 35 wt % of the dianhydride, and the PDA is in an amount from 10 to 70 wt % of the diamine; carbon black in an amount from 2 to 8 wt % of the alkali-resistant black matte polyimide film; and polyimide micropowder having a particle size between 2 and 10 μm and being in an amount from 5 to 10 wt % of the alkali-resistant black matte polyimide film.

### BACKGROUND OF THE INVENTION

This non-provisional application claims priority under 35 U.S.C. § 119(a) on Patent Application No(s). 110149409 filed in Taiwan, R.O.C. on Dec. 29, 2021, the entire contents of which are hereby incorporated by reference.

### BACKGROUND OF THE INVENTION

### 1. Field of the Invention

The present disclosure relates to an alkali-resistant black matte polyimide film, in which the polyimide film is obtained by chemical cyclization after the polymerization of dianhydride and diamine, and the black matte polyimide film includes carbon black in an amount from 2 to 8 wt % of the alkali-resistant black matte polyimide film, and includes polyimide micropowder having a particle size between 2 and 10 μm and being in an amount from 5 to 10 wt % of the alkali-resistant black matte polyimide film, such that the alkali-resistant black matte polyimide film has a gloss value at 60° ranging from 5 to 30, and has a thermal expansion coefficient of less than 35 ppm/° C.

### 2. Description of the Related Art

Polyimide (PI) has the characteristics such as good heat resistance, chemical resistance, mechanical strength and high electrical impedance, and has been widely used in the electronic industry, for example, as a printed circuit board material. However, some electronic products contact strong alkali during the wet process, and polyimide is easily affected by the strong alkali, resulting in ring-opening hydrolysis, reduction of structural stability or even damage. Hence, there is a need to develop an alkali-resistant black matte polyimide film.

U.S. Pat. No. 9,631,054B2 discloses a black polyimide film, in which polyimide micropowder is used as a matting agent, and its base composition includes pyromellitic dianhydride (PMDA) and 4,4′-oxydianiline (ODA). Since the polyimide micropowder and the polyimide base are organic materials, the thermal expansion coefficient of the black polyimide film is higher than that made of the inorganic matting powder. The higher thermal expansion coefficient causes the problem of warpage after the glue and copper are adhered in the subsequent process due to the large difference in the thermal expansion coefficient between the organic material and the adhesion.

U.S. Pat. No. 10,336,045B2 discloses the polyimide composition including pyromellitic dianhydride (PMDA), 4,4′-oxydianiline (ODA) and p-phenylenediamine (PDA), wherein in the base composition, 4,4′-oxydianiline (ODA) is in amount from 20 to 80% of the number of moles of diamine, and p-phenylenediamine (PDA) is in amount from 80 to 20% of the number of moles of diamine. The base composition solves the problem of higher thermal expansion coefficient. However, when the ratio of p-phenylenediamine is too high, the alkali resistance will decrease. In the subsequent soft board processing procedure, an alkaline solution is frequently used, and thus insufficient alkali resistance will cause problems such as powder drop, optical property variation, and gloss reduction.

### BRIEF SUMMARY OF THE INVENTION

When there are 5-15mol % of p-phenylenediamine and 95-85 mol % of 4,4′-oxydianiline contained in the polyimide, the thermal expansion coefficient is less than 41 ppm/° C., but it is difficult to be less than 35 ppm/° C. To obtain a smaller thermal expansion coefficient, the mole percent (mol %) of p-phenylenediamine must be increased to more than 20 mol %; however, this will reduce the alkali resistance of polyimide. 3,3′,4,4′-biphenyltetracarboxylic dianhydride (BPDA) can be used to replace some of PMDA, so as to obtain better alkali resistance of polyimide and also increase the mole percent of p-phenylenediamine to 20 mol % or more, resulting in a lower thermal expansion coefficient of the black polyimide film.

The present disclosure provides a black matte polyimide film with a lower thermal expansion coefficient and better alkali resistance.

The alkali-resistant black matte polyimide film of the present disclosure includes: polyimide in an amount from 75 to 93 wt % of the alkali-resistant black matte polyimide film, in which dianhydride and diamine are polymerized to form a polyimide precursor, and the polyimide precursor is chemically cyclized to form the polyimide, wherein the dianhydride includes pyromellitic dianhydride (PMDA) and 3,3′,4,4′-biphenyltetracarboxylic dianhydride (BPDA), and the diamine includes p-Phenylenediamine (PDA) and 4,4′-oxydianiline (ODA), and wherein the BPDA is an amount from 2 to 35 wt % of the dianhydride, and the PDA is in an amount from 10 to 70 wt % of the diamine; carbon black in an amount from 2 to 8 wt % of the alkali-resistant black matte polyimide film; and polyimide micropowder having a particle size between 2 and 10 μm and being in an amount from 5 to 10 wt % of the alkali-resistant black matte polyimide film, wherein the alkali-resistant black matte polyimide film has a gloss value at 60° ranging from 5 to 30, and has a thermal expansion coefficient of less than 35 ppm/° C.

### DETAILED DESCRIPTION OF THE INVENTION

In the present disclosure, he alkali-resistant black matte polyimide film includes: polyimide in an amount from 75 to 93 wt % of the alkali-resistant black matte polyimide film, in which dianhydride and diamine are polymerized to form a polyimide precursor, and the polyimide precursor is chemically cyclized to form the polyimide, wherein the dianhydride includes pyromellitic dianhydride (PMDA) and 3,3′,4,4′-biphenyltetracarboxylic dianhydride (BPDA), and the diamine includes p-Phenylenediamine (PDA) and 4,4′-oxydianiline (ODA), and wherein the BPDA is an amount from 2 to 35 wt % of the dianhydride, and the PDA is in an amount from 10 to 70 wt % of the diamine; carbon black in an amount from 2 to 8 wt % of the alkali-resistant black matte polyimide film; and polyimide micropowder having a particle size between 2 and 10 μm and being in an amount from 5 to 10 wt % of the alkali-resistant black matte polyimide film, wherein the alkali-resistant black matte polyimide film has a gloss value at 60° ranging from 5 to 30, and has a thermal expansion coefficient of less than 35 ppm/° C.

In an embodiment, the mole percent of PDA is greater than or equal to twice of the mole percent of BPDA.

Preparation of Polyamic Acid Solution

Polyimide is made of dianhydride and diamine, and wherein dianhydride is pyromellitic dianhydride (PMDA), and diamine is 4,4′-oxydianiline (ODA) and p-phenylenediamine (PDA). Increasing the amount of p-phenylenediamine (PDA) results in the reduction of alkali resistance, and insufficient PDA increases the thermal expansion coefficient. Hence, in the present disclosure, p-phenylenediamine (PDA) is in an amount from 10% to 70% of the total mol % of diamine. Also, 4,4′-oxydianiline is in an amount from 90% to 30% of the total mol % of diamine, and 3,3′,4,4′-biphenyltetracarboxylic dianhydride (BPDA) is in an amount from 2 to 35 wt % of the dianhydride.

In the preparation of polyamic acid solution, p-phenylenediamine (PDA) is mixed with a solvent to form a mixture, and then then mixture is added with a small amount of pyromellitic dianhydride (PMDA) to form the first segment, and the number of moles of the diamine in the first segment needs to be greater than that of the dianhydride. In the preparation of polyimide solution, dimethylacetamide (DMAc), N-methylpyrrolidone (NMP), N-ethyl-2-pyrrolidone (NEP), γ-butyrolactone (GBL), N,N-dimethylformamide (DMF) can be used as the solvent. In this embodiment, dimethylacetamide (DMAc) is used as the solvent.

The first segment solution is added with 4,4′-oxydianiline (ODA), after the mixture is completely dissolved, pyromellitic dianhydride (PMDA) is added and stirred for 1 hour, and then 3,3′,4,4′-biphenyltetracarboxylic dianhydride (BPDA) is added. Then, viscosity adjustment is performed so as to adjust the viscosity of the solution to 100,000 cps-250,000 cps. At this time, the solid content of the solution can be between 15 and 25 wt %, that is, the preparation of the polyamic acid solution is completed.

Preparation of Polyimide Micropowder

In the preparation of polyimide micropowder, 4,4′-oxydianiline (ODA) and dimethylacetamide are mixed in a three-necked flask, and then pyromellitic dianhydride (PMDA) was slowly added. The mixture is continuously stirred and heated at about 170° C., and the reaction is carried out for about 18 hours to obtain a polyimide precipitate. The polyimide precipitate is washed with water and ethanol, vacuum filtered, heated and dried at about 160° C. for about 1 hour, and thus polyimide fine powder is obtained. The average particle size of the obtained powder was detected by a particle size analyzer (model Horiba LA-950, sold by Horiba, Instruments Inc.).

In the polyimide micropowder, a monomer molar ratio of the diamine compound to the dianhydride compound is in a range from 1:0.950 to 1:0.995, and the solid content is controlled between 15 and 25 wt % during polymerization. The polyimide micropowder with a particle size between 2 and 10 μm is obtained. The effective particle size (S) of the polyimide micropowders is more than 70%, and the effective particle size (S) is defined as:

S=B/(A+B+C)×100%
A: percentage of polyimide micropowder with particle size less than 2 μm;
B: percentage of polyimide micropowder with particle size 2-10 μm;
C: percentage of polyimide micropowder with particle size greater than 10 μm.

Preparation of Black Matte Slurry

The carbon black, polyimide micropowder and dimethylacetamide are prepared into a solution in a weight ratio of 1:1.95:17.7. After the solution was stirred and mixed evenly, the solution is ground with 0.8 mm zirconium beads for 30 minutes with a zirconium bead filling rate of 50% by volume to form the black matte slurry.

The carbon black in the black matte slurry is insulating carbon black. In the present disclosure, Evonik SPECIAL BLACK 4A (SB4A) is used as the insulating carbon black.

The weight ratio of carbon black, polyimide micropowder and dimethylacetamide in the black matte slurry can be adjusted as required, wherein the weight ratio between carbon black and polyimide micropowder is related to penetration and gloss. In the present disclosure, the carbon black is in an amount from 2 to 8% of the weight of the black polyimide film, and the polyimide micropowder is in an amount from 5 to 10% of the weight of the black polyimide film.

Preparation of Black Matte Polyimide Film

The black matte slurry and the polyamic acid solution are mixed and stirred evenly, and then a catalyst and a dehydrating agent are added for chemical cyclization. The dehydrating agent can be acetic anhydride or benzoic anhydride. In the present disclosure, acetic anhydride is used as the dehydrating agent, wherein the catalyst can be pyridine, 3-methylpyridine, 2-methylpyridine, 4-methylpyridine, isoquinoline, quinoline and triethylamine, and the preferred catalysts are 3-methylpyridine, 2-methylpyridine and 4-methylpyridine. In the present disclosure, 3-methylpyridine is used as the catalyst.

The catalyzer and the dehydrating agent can be used alone, or can be mixed and diluted with solvent, and then be added in the mixture of the black matte slurry and the polyamic acid solution to form a mixed solution. After being stirred evenly, the mixed solution is defoamed by a centrifugal defoaming machine. After being applied to a glass plate, the defoamed solution is coated on the glass plate by a blade with a gap of 300 μm. The coated sample is placed in an oven at 80° C. for 20 minutes, heated to 170° C. for 20 minutes, and then heated to 350° C. for 20 minutes as the final treatment. Then, the glass plate is placed in water, and the film is removed to obtain a black matte polyimide film.

In addition to a glass plate, a metal plate can be used in the above preparation. In the case that a metal plate is used in the preparation of a black matte polyimide film, after the coated sample is baked and dried in an oven at 80° C., the semi-dry film needs to be removed from the metal plate. The semi-dry film is fixed on a metal frame, heated to 170° C. for 20 minutes, and then heated to 350° C. for 20 minutes, such that a black matte polyimide film is obtained.

In the present disclosure, the black matte polyimide film has a thickness of 5 μm to 100 μm.

The black matte polyimide film can be used as a cover film, which has an adhesive layer and a base film.

### EXAMPLES

<Detection Methods>

Various properties of the composite films obtained in the following examples were measured using the following methods.

Thermal expansion coefficient (100° C.-200° C.): according to ASTM D696 standard, the model Q400 TMA instrument from TA Instruments is used for the measurement. The thermal expansion coefficient of the polyimide film is measured at 100° C. to 200° C., and the heating rate is set to 10° C./min. In order to eliminate the stress caused by the heat treatment, after removing the residual stress by the first measurement, the second measurement result is used as the actual value.

Optical transmittance: according to ISO 14782 standard, the model NDH-2000N instrument from Nippon Denshoku company is used for the measurement.

Gloss: the BYK brand, model micro-TRI-gloss gloss meter is used to measure the gloss at 60 degrees.

Alkali resistance test: The black matte polyimide film is immersed in 10 wt % NaOH aqueous solution at 50° C. for 10 min. The difference in gloss at 60 degrees before and after immersion is measured, and this optical property is used as the evaluation of alkali resistance.

### Example 1

Preparation of Polyimide Micropowder

14.35 g of 4,4′-diaminodiphenyl ether (ODA), 14.86 g of pyromellitic dianhydride (PMDA) and 570 g of dimethylacetamide were placed to form a mixture in a three-necked flask, in which a monomer molar ratio of 4,4′-diaminodiphenyl ether (ODA) to pyromellitic dianhydride (PMDA) is 1:0.980, and the solid content is 6 wt %. The mixture was stirred and heated at 170° C. for 18 hours to obtain the polyimide precipitate. The precipitate was washed by water and ethanol, vacuum filtered, heated and dried at 160° C. for about 1 hour, and thus polyimide micropowder is obtained. The average particle size of the obtained powder detected by a particle size analyzer (model Horiba LA-950, sold by Horiba, Instruments Inc.) was 2.4 μm. The effective particle size (S) of the polyimide micropowders is 93%.

Preparation of Polyamic Acid Solution

16.64 g of p-phenylenediamine (PDA) was added in 451 g of dimethylacetamide to form a mixture, and the mixture was stirred. After p-phenylenediamine (PDA) was completely dissolved, 11.19 g of pyromellitic dianhydride (PMDA) was added and stirred, and the reaction was carried out for 30 minutes. Then, 20.54 g of 4,4′-oxydianiline (ODA) was added and dissolved, then 27.99 g of pyromellitic dianhydride (PMDA) was slowly added, and the temperature was kept at 25° C. After the reaction was carried out for one hour, 18.87 g of 3,3′,4,4′-biphenyltetracarboxylic dianhydride (BPDA) was added, and after 30 minutes of reaction, a trace amount of 3,3′,4,4′-biphenyltetracarboxylic dianhydride (BPDA) was gradually used to adjust the viscosity to form a polyamic acid solution with a solid content of 18 wt % and a viscosity of 165,000 cps.

Preparation of Black Matte Slurry

The Evonik SPECIAL BLACK 4A (SB4A) insulating carbon black, polyimide micropowder and dimethylacetamide were placed into a solution in a weight ratio of 1:1.95:17.7. After the solution was stirred and mixed evenly, the solution is ground with 0.8 mm zirconium beads for 30 minutes with a zirconium bead filling rate of 50% by volume. After being ground, 6 g of the solution was taken out and added with 40 g of polyamic acid solution, and the mixture was stirred and mixed evenly. Acetic anhydride and dimethylacetamide were diluted in a weight ratio of 2 to 1, and 3-methylpyridine and dimethylacetamide were diluted a weight ratio of 1 to 1. Then, 8.9 ml of the diluted acetic anhydride solution and 5.1 ml of the diluted 3-methylpyridine solution were added to the mixture of the polyamic acid solution and the ground solution. After being stirred and mixed evenly, the mixed solution was defoamed by a centrifugal defoaming machine. After being applied to a glass plate, the defoamed solution was coated on the glass plate by a blade with a gap of 300 μm. The coated sample was placed in an oven at 80° C. for 20 minutes, heated to 170° C. at a rate of 1.8° C./min for 20 minutes, and then heated to 350° C. at a rate of 2.0° C./min for 20 minutes as the final treatment.

### Example 2

The preparation of polyimide micropowder is the same as that in Example 1.

Preparation of Polyamic Acid Solution

16.97 g of p-phenylenediamine (PDA) was added in 451 g of dimethylacetamide to form a mixture, and the mixture was stirred. After p-phenylenediamine (PDA) was completely dissolved, 11.42 g of pyromellitic dianhydride (PMDA) was added and stirred, and the reaction was carried out for 30 minutes. Then, 20.95 g of 4,4′-oxydianiline (ODA) was added and dissolved, then 34.26 g of pyromellitic dianhydride (PMDA) was slowly added, and the temperature was kept at 25° C. After the reaction was carried out for one hour, 11.55 g of 3,3′,4,4′-biphenyltetracarboxylic dianhydride (BPDA) was added, and after 30 minutes of reaction, a trace amount of 3,3′,4,4′-biphenyltetracarboxylic dianhydride (BPDA) was gradually used to adjust the viscosity to form a polyamic acid solution with a solid content of 18 wt % and a viscosity of 166,000 cps.

Preparation of Black Matte Slurry

The Evonik SPECIAL BLACK 4A (SB4A) insulating carbon black, polyimide micropowder and dimethylacetamide were placed into a solution in a weight ratio of 1:1.95:17.7. After the solution was stirred and mixed evenly, the solution is ground with 0.8 mm zirconium beads for 30 minutes with a zirconium bead filling rate of 50% by volume. After being ground, 6 g of the solution was taken out and added with 40 g of polyamic acid solution, and the mixture was stirred and mixed evenly. Acetic anhydride and dimethylacetamide were diluted in a weight ratio of 2 to 1, and 3-methylpyridine and dimethylacetamide were diluted a weight ratio of 1 to 1. Then, 9.1 ml of the diluted acetic anhydride solution and 5.2 ml of the diluted 3-methylpyridine solution were added to the mixture of the polyamic acid solution and the ground solution. After being stirred and mixed evenly, the mixed solution was defoamed by a centrifugal defoaming machine. After being applied to a glass plate, the defoamed solution was coated on the glass plate by a blade with a gap of 300 μm. The coated sample was placed in an oven at 80° C. for 20 minutes, heated to 170° C. at a rate of 1.8° C./min for 20 minutes, and then heated to 350° C. at a rate of 2.0° C./min for 20 minutes as the final treatment.

### Example 3

The preparation of polyimide micropowder is the same as that in Example 1.

Preparation of Polyamic Acid Solution

7.91 g of p-phenylenediamine (PDA) was added in 451 g of dimethylacetamide to form a mixture, and the mixture was stirred. After p-phenylenediamine (PDA) was completely dissolved, 5.32 g of pyromellitic dianhydride (PMDA) was added and stirred, and the reaction was carried out for 30 minutes. Then, 34.17 g of 4,4′-oxydianiline (ODA) was added and dissolved, then 37.25 g of pyromellitic dianhydride (PMDA) was slowly added, and the temperature was kept at 25° C. After the reaction was carried out for one hour, 10.76 g of 3,3′,4,4′-biphenyltetracarboxylic dianhydride (BPDA) was added, and after 30 minutes of reaction, a trace amount of 3,3′,4,4′-biphenyltetracarboxylic dianhydride (BPDA) was gradually used to adjust the viscosity to form a polyamic acid solution with a solid content of 18 wt % and a viscosity of 169,000 cps.

Preparation of Black Matte Slurry

The Evonik SPECIAL BLACK 4A (SB4A) insulating carbon black, polyimide micropowder and dimethylacetamide were placed into a solution in a weight ratio of 1:1.95:17.7. After the solution was stirred and mixed evenly, the solution is ground with 0.8 mm zirconium beads for 30 minutes with a zirconium bead filling rate of 50% by volume. After being ground, 6 g of the solution was taken out and added with 40 g of polyamic acid solution, and the mixture was stirred and mixed evenly. Acetic anhydride and dimethylacetamide were diluted in a weight ratio of 2 to 1, and 3-methylpyridine and dimethylacetamide were diluted a weight ratio of 1 to 1. Then, 9.2 ml of the diluted acetic anhydride solution and 5.3 ml of the diluted 3-methylpyridine solution were added to the mixture of the polyamic acid solution and the ground solution. After being stirred and mixed evenly, the mixed solution was defoamed by a centrifugal defoaming machine. After being applied to a glass plate, the defoamed solution was coated on the glass plate by a blade with a gap of 300 μm. The coated sample was placed in an oven at 80° C. for 20 minutes, heated to 170° C. at a rate of 1.8° C./min for 20 minutes, and then heated to 350° C. at a rate of 2.0° C./min for 20 minutes as the final treatment.

### Comparative Example 1

The preparation of polyimide micropowder is the same as that in Example 1.

Preparation of Polyamic Acid Solution

9.7 g of p-phenylenediamine (PDA) was added in 451 g of dimethylacetamide to form a mixture, and the mixture was stirred. After p-phenylenediamine (PDA) was completely dissolved, 33.36 g of 4,4′-oxydianiline (ODA) was added. After 4,4′-oxydianiline (ODA) was completely dissolved, 53.14 g of pyromellitic dianhydride (PMDA) was slowly added, and the temperature was kept at 25° C. After the reaction was carried out for one hour, a trace amount of pyromellitic dianhydride (PMDA) was gradually used to adjust the viscosity to form a polyamic acid solution with a solid content of 18 wt % and a viscosity of 164,000 cps.

Preparation of Black Matte Slurry

The Evonik SPECIAL BLACK 4A (SB4A) insulating carbon black, polyimide micropowder and dimethylacetamide were placed into a solution in a weight ratio of 1:1.95:17.7. After the solution was stirred and mixed evenly, the solution is ground with 0.8 mm zirconium beads for 30 minutes with a zirconium bead filling rate of 50% by volume. After being ground, 6 g of the solution was taken out and added with 40 g of polyamic acid solution, and the mixture was stirred and mixed evenly. Acetic anhydride and dimethylacetamide were diluted in a weight ratio of 2 to 1, and 3-methylpyridine and dimethylacetamide were diluted a weight ratio of 1 to 1. Then, 8.9 ml of the diluted acetic anhydride solution and 5.1 ml of the diluted 3-methylpyridine solution were added to the mixture of the polyamic acid solution and the ground solution. After being stirred and mixed evenly, the mixed solution was defoamed by a centrifugal defoaming machine. After being applied to a glass plate, the defoamed solution was coated on the glass plate by a blade with a gap of 300 μm. The coated sample was placed in an oven at 80° C. for 20 minutes, heated to 170° C. at a rate of 1.8° C./min for 20 minutes, and then heated to 350° C. at a rate of 2.0° C./min for 20 minutes as the final treatment.

### Comparative Example 2

The preparation of polyimide micropowder is the same as that in Example 1.

Preparation of Polyamic Acid Solution

33.36 g of 4,4′-oxydianiline (ODA) was added in 451 g of dimethylacetamide to form a mixture, and the mixture was stirred. After 4,4′-oxydianiline (ODA) was completely dissolved, 49.05 g of pyromellitic dianhydride (PMDA) was added, and the temperature was kept at 25° C. After the reaction was carried out for one hour, a trace amount of pyromellitic dianhydride (PMDA) was gradually used to adjust the viscosity to form a polyamic acid solution with a solid content of 18 wt % and a viscosity of 169,000 cps.

Preparation of Black Matte Slurry

The Evonik SPECIAL BLACK 4A (SB4A) insulating carbon black, polyimide micropowder and dimethylacetamide were placed into a solution in a weight ratio of 1:1.95:17.7. After the solution was stirred and mixed evenly, the solution is ground with 0.8 mm zirconium beads for 30 minutes with a zirconium bead filling rate of 50% by volume. After being ground, 6 g of the solution was taken out and added with 40 g of polyamic acid solution, and the mixture was stirred and mixed evenly. Acetic anhydride and dimethylacetamide were diluted in a weight ratio of 2 to 1, and 3-methylpyridine and dimethylacetamide were diluted a weight ratio of 1 to 1. Then, 8.9 ml of the diluted acetic anhydride solution and 5.1 ml of the diluted 3-methylpyridine solution were added to the mixture of the polyamic acid solution and the ground solution. After being stirred and mixed evenly, the mixed solution was defoamed by a centrifugal defoaming machine. After being applied to a glass plate, the defoamed solution was coated on the glass plate by a blade with a gap of 300 μm. The coated sample was placed in an oven at 80° C. for 20 minutes, heated to 170° C. at a rate of 1.8° C./min for 20 minutes, and then heated to 350° C. at a rate of 2.0° C./min for 20 minutes as the final treatment.

The following table shows the comparison between Examples and Comparative Examples.

| | | | | | | | | | optical | | | |
|---|---|---|---|---|---|---|---|---|---|---|---|---|
| | | | | | | | | | transmit- | | | |
| | | | | | | polyimide | Thermal | optical | tance | | gloss | |
| | | | | | carbon | micro- | expansion | transmit- | NaOH 10 | | NaOH 10 | gloss |
| | dianhydride | | diamine | | black | powder | coefficient | tance | wt %, 50° | gloss | wt %, 50° | change |
| | mol % | | mol % | | wt % | wt % | ppm/° C. | % | C., 10 min | — | C., 10 min | — |
| Example 1 | PMDA 70 | BPDA 30 | ODA 40 | PDA 60 | 3.9 | 7.6 | 14 | 0.51 | 0.40 | 23.0 | 20.5 | 8% |
| Example 2 | PMDA 80 | BPDA 20 | ODA 40 | PDA 60 | 3.9 | 7.6 | 15 | 0.38 | 0.35 | 23.3 | 19.8 | 15% |
| Example 3 | PMDA 80 | BPDA 20 | ODA 70 | PDA 30 | 3.9 | 7.6 | 28 | 0.39 | 0.38 | 23..2 | 21 | 9% |
| Comparative | PMDA 100 | BPDA 0 | ODA 65 | PDA 35 | 3.9 | 7.6 | 25 | 0.45 | 5.1 | 23.3 | 9 | 61% |
| Example 1 | | | | | | | | | | | | |
| Comparative | PMDA 100 | BPDA 0 | ODA 100 | PDA 0 | 3.9 | 7.6 | 33 | 0.49 | 3.8 | 23.2 | 20.1 | 13% |
| Example 2 | | | | | | | | | | | | |

While the present disclosure has been described by means of specific embodiments, numerous modifications and variations could be made thereto by those skilled in the art without departing from the scope and spirit of the present disclosure set forth in the claims.

What is claimed is:

1. An alkali-resistant black matte polyimide film, comprising:
polyimide in an amount from 75 to 93 wt % of the alkali-resistant black matte polyimide film, in which dianhydride and diamine are polymerized to form a polyimide precursor, and the polyimide precursor is chemically cyclized to form the polyimide, wherein the dianhydride includes pyromellitic dianhydride (PMDA) and 3,3′,4,4′-biphenyltetracarboxylic dianhydride (BPDA), and the diamine includes p-Phenylenediamine (PDA) and 4,4′-oxydianiline (ODA), and wherein the BPDA is an amount from 2 to 35 wt % of the dianhydride, and the PDA is in an amount from 10 to 70 wt % of the diamine;
carbon black in an amount from 2 to 8 wt % of the alkali-resistant black matte polyimide film; and
polyimide micropowder having a particle size between 2 and 10 μm and being in an amount from 5 to 10 wt % of the alkali-resistant black matte polyimide film,
wherein the alkali-resistant black matte polyimide film has a gloss value at 60° ranging from 5 to 30, and has a thermal expansion coefficient of less than 35 ppm/° C.

2. The alkali-resistant black matte polyimide film according to claim 1, having a thickness ranging from 5 to 100 μm.

3. The alkali-resistant black matte polyimide film according to claim 1, wherein a mole percent of the PDA in the alkali-resistant black matte polyimide film is greater than or equal to twice of a mole percent of the BPDA in the alkali-resistant black matte polyimide film.

4. The alkali-resistant black matte polyimide film according to claim 1, wherein after being soaked in 10 wt % NaOH at 50° C. for 10 minutes, an optical transmittance of the alkali-resistant black matte polyimide film changes less than 0.1%, and the gloss changes less than 40%.

5. The alkali-resistant black matte polyimide film according to claim 1, wherein the polyimide micropowder is formed by a reaction of a diamine compound and a dianhydride compound, and a monomer molar ratio of the diamine compound to the dianhydride compound is in a range from 1:0.950 to 1:0.995.
